(19) United States
(12) Patent Application Publication
(10) Pub. No.: US 2017/0028819 A1
(43) Pub. Date: Feb. 2, 2017

(54) HEATING AND DRYING DEVICE FOR USE IN MOTOR VEHICLES

(71) Applicant: ALTERNATIVE ENERGY CONSULTING & TECHNOLOGIES S.A.R.L., Surré (LU)

(72) Inventor: Claude BOUVY, Luxembourg (LU)

(21) Appl. No.: 15/303,822

(22) PCT Filed: Apr. 23, 2015
(86) PCT No.: PCT/EP2015/058842

§ 371 Date: Oct. 13, 2016

(30) Foreign Application Priority Data
Apr. 24, 2014 (LU) 92436

(51) Int. Cl. B60H 3/02

(52) U.S. Cl. CPC B60H 3/022; B60H 3/024; B60H 2003/028

(57) ABSTRACT

A heating and drying device for use in a motor vehicle; a method for using a heating and drying device of this type for increasing the temperature of an operating fluid of the motor vehicle, and/or for drying the air of a motor vehicle cabin of the motor vehicle; and a heating and drying system having a heating and drying device of this type for use in a motor vehicle.

The present invention relates to a heating and drying device for use in motor vehicles according to the introductory clause of claim 1, and a method for increasing the temperature of an operating fluid of a motor vehicle and/or for drying the air of a motor vehicle cabin of the motor vehicle using such a device.

### PRIOR ART

In the prior art, heating and drying devices with adsorption units are known for use in motor vehicles. The adsorption units contain an adsorption agent (adsorbent), which is suitable for the reversible adsorption and desorption of water vapor. For the desorption of the water vapor by the adsorbent (drying), energy must be applied, which in a subsequent adsorption of water vapor is released by the adsorbent. For example, zeolites and silica gels are known as suitable adsorption agents.

European patent application EP 1 547 834 A1 describes a conditioning system for a vehicle, with which conditioning system the air which is to be introduced into a vehicle interior can be conditioned. The conditioning system comprises a drying facility, able to be flowed through by the air, through which facility moisture is able to be extracted from the air. For this purpose, the drying facility comprises a zeolite arrangement which is able to be flowed through by the air which is to be introduced into the interior. In order to bring the zeolite arrangement into a state for renewed reception of moisture again, the drying facility is heated by the supplying of heat from a heat source. The heat source can be formed by a fuel-operated burner or/and an exhaust gas routing system of an internal combustion engine, or/and a fuel cell or/and an electrically operable heater.

In patent application DE 102 33 762 A1 a device is described for the climate control of motor vehicles, by means of which an excess consumption of fuel, necessary for air conditioning systems of motor vehicles, can be reduced. The device comprises a vapor adsorber, which is in flow connection with a fluid store of a heat exchanger, cooled by extraction of vaporization heat, or with an air stream which is to be dehumidified before a cooling by a cooling compressor, wherein the vapor adsorber is able to be regenerated by the waste heat of the drive motor of the motor vehicle, in particular the waste heat of the exhaust system of the motor vehicle, with expulsion of the received vapor. Preferably zeolites are used for the formation of the vapor adsorber. A rapid heating of the cooling water for the drive motor can be achieved via connection with a cooling circuit for the drive motor of the motor vehicle, with air-conditioning not being necessary, especially in winter operation of the vehicle, by the heat generated by the zeolite adsorber during receiving of water vapor being supplied to the cooling water.

A further air dehumidifier for a motor vehicle is described in patent document DE 100 45 974 C1. With the air dehumidifier, moist air is drawn out from the vehicle interior in particular during the cold start, is fed to a drying unit with is filled with a hydrophilic sorbent, and is directed back from there, in dried state, to the vehicle interior. The hydrophilic sorbent, which is formed from salt, is situated in a container fastened to the engine block in thermal contact with the internal combustion engine of the motor vehicle.

### DISCLOSURE OF THE INVENTION

In the case of low external temperatures, motor vehicles are often below desired operating temperatures at the start of travel. This applies both to temperatures of the operating fluids of the motor vehicle, for example engine oil or coolant, and also to the vehicle cabin temperature of the motor vehicle. Furthermore, the relative humidity in the vehicle cabin after the start of travel is rapidly increased by the breathing and/or sweating of occupants of the motor vehicle, so that the formation of condensation can occur on the windows, by which the visibility can be impeded for the occupants of the vehicle cabin, in particular for the driver of the motor vehicle.

For reasons of high efficiency and for comfort and safety reasons, it is desirable to bring the said temperatures as quickly as possible to the desired operating temperatures and/or to reduce the relative humidity of the vehicle interior. This aim is achieved by the subject of the present invention.

The subject of the present invention is a heating and drying device for use in a motor vehicle, comprising:
an adsorption unit with an adsorbent which is suitable for the reversible adsorption or respectively desorption of water,
a heat exchanger, which is in heat-transferring contact both with the adsorbent of the adsorption unit and also with a waste heat source which is active at least when the motor vehicle is in operation and, in at least one operating state, is designed to transfer heat from the waste heat source to the adsorbent of the adsorption unit, and
a valve unit, which is designed to provide access paths for air to the adsorbent and to control the access of the air to the adsorbent.

“Adsorption/desorption of water” is to be understood in this context in particular to mean a physical adsorption/desorption, in which water molecules on the surface of the adsorbent are accumulated/removed without formation/breakup of chemical bonds.

These water molecules originate either form the air (as water vapor) and/or are applied onto the surface of the adsorbent as liquid water by a special device. In this context, it is to be mentioned that the liquid water can also contain an antifreeze agent.

It is proposed that the waste heat source is formed by an operating fluid of the motor vehicle and the heat exchanger is thereby also in heat-transferring contact with the operating fluid of the motor vehicle and is designed, in at least one operating state, to transfer heat from the adsorbent to the operating fluid of the motor vehicle.

With an embodiment of the device according to the invention, advantageously a waste heat occurring during the operation of the motor vehicle can be stored and utilized to heat the operating fluid of the motor vehicle to a desired operating temperature in a shorter time at a future start of travel.

Furthermore, in a suitable configuration, during the future start of travel the water vapor content of the air situated in the vehicle cabin can be reduced, so that a misting of the windows by condensing water vapor can be reduced or prevented, whereby the driving safety can be increased.

As the physical adsorption of the water by the adsorbent or respectively the physical desorption of the water by the adsorbent takes place substantially reversibly, i.e. without energy loss, the heat transmission can be carried out particularly efficiently.

Preferably zeolites (e.g. NaY, 13X), silica gels (e.g. Köstrosorb®) etc. can be used as adsorbent.

In addition, it is proposed that the adsorption unit has a hermetically sealable housing to receive the adsorbent. “Hermetically closed” is to be understood in this context in particular to mean that an exchange of gases or liquids between the housing and the surrounding outside space is prevented.

Thereby, a long storage time of the adsorption energy can be achieved, although the temperature of the adsorbent approaches the ambient temperature during an interruption of the operation of the motor vehicle.

When the operating fluid of the vehicle is selected from a group which is formed by gear oil, engine oil and coolant, through the accelerated reaching of the desired operating temperatures, friction losses through high viscosity can be reduced or respectively an operating point of the engine with high efficiency can be reached more quickly, whereby an improved overall efficiency of the motor vehicle can be achieved.

Furthermore, it is proposed that at least one of the access paths provided by the valve unit is formed by a connection, capable of conducting air, between a vehicle cabin of the motor vehicle and a space surrounding the vehicle cabin. Thereby, in a suitable configuration, in the case of very low external temperatures, for example at a temperature below 0° C., at which the water vapor partial pressure of the air is very low, by access of the air from the vehicle cabin of the motor vehicle, water vapor can be fed to the adsorbent, which water vapor was generated by the breathing and/or sweating at least of the driver of the motor vehicle. Thereby, a reliable releasing of the adsorption energy at the adsorbent can be guaranteed and, at the same time, the water vapor content of the air in the vehicle cabin of the motor vehicle can be lowered.

When the valve unit of the heating and drying device has at least one vacuum valve, it can be achieved that the housing of the adsorption unit, cooling after an interruption of the operation of the motor vehicle, is still able to be hermetically sealed, whereby an undesired adsorption of water or respectively water vapor at the adsorbent can be largely prevented.

In a further advantageous configuration, the heating and drying device comprises a ventilation unit, which is provided to convey air on at least one of the access paths provided by the valve unit. Thereby, also during a standing phase of the motor vehicle, water can be fed to the adsorbent, and the adsorption heat which is being released can be transferred from the adsorbent to the operating fluid of the motor vehicle.

In addition, it is proposed that the adsorption unit of the heating and drying device is integrated either into a container provided for receiving the operating fluid of the vehicle, or into the waste heat source which is active when the motor vehicle is in operation. “Integrated” is to be understood in this context in particular to mean that the adsorption unit is substantially completely surrounded by the container or respectively the waste heat source, or that the adsorption unit and the container or respectively the waste heat source have at least one shared housing element.

In this way, through short distances between the adsorption unit and the operating fluid or respectively the waste heat source, good heat transmission values can be achieved for the transmission of heat, and savings can be made with regard to components.

A further subject of the present invention is a method for
increasing the temperature of an operating fluid of a motor vehicle and/or for
drying the air of a vehicle cabin of the motor vehicle
   using a heating and drying device according to one of the previously disclosed embodiments and further developments or a combination thereof.

The method is characterized by the following steps:
providing, by means of the valve unit, an access path for air from at least one of air spaces which are formed by the space surrounding the vehicle cabin, and the vehicle cabin of the motor vehicle, to the adsorbent,
providing, by means of the valve unit, an access path for air from the adsorbent to at least one of the air spaces which are formed by the space surrounding the vehicle cabin, and the vehicle cabin of the motor vehicle, and
transferring of heat from the adsorption unit to the operating fluid of the motor vehicle.

In a further advantageous configuration of the method, the heating and drying device comprises in addition a temperature sensor for determining the temperature of the adsorbent, a temperature sensor for determining the temperature of the operating fluid, and a temperature sensor for determining the temperature of the waste heat of the motor vehicle, and the method contains as a step a closing of the access paths for air, provided by means of the valve unit, when after a rise in temperature of the adsorbent owing to adsorption of water by the adsorbent, a difference in the temperature of the adsorbent and the temperature of the operating fluid of the motor vehicle falls below a first predetermined value.

For the purpose of the desorption of the adsorbed water on the adsorbent, the method comprises as a step an opening of the access paths for air, provided by means of the valve unit, when the difference in the temperature of the waste heat source of the motor vehicle and the temperature of the adsorbent exceeds a second predetermined value.

A further aspect of the invention is the provision of a heating and drying system for use in a motor vehicle. The heating and drying system comprises an embodiment of one of the described heating and drying devices or a combination thereof, wherein the valve unit comprises at least one controllable valve. A “controllable valve” is to be understood in this context to mean in particular a valve, the valve positions of which can be altered remotely by an externally changeable control amount. In particular, the externally changeable control amounts can be formed by compressed air (pneumatically controllable valve), a hydraulic fluid, an electrical voltage (electromagnetically controllable valve) or a mechanical force.

Furthermore, the heating and drying system contains a temperature sensor for determining the temperature of the adsorbent, a temperature sensor for determining the temperature of the waste heat source of the motor vehicle, a temperature sensor for determining the temperature of the operating fluid of the motor vehicle and a monitoring and control unit, which is designed to control the valve unit for the provision of access paths of air to the adsorbent and for the monitoring of the access of air to the adsorbent as a function of temperatures determined by the temperature sensors.

In this way, the storage of the waste heat and the heating of the operating fluid of the motor vehicle at a future start of travel can be achieved reliably and automatically, without the assistance of a user.

In a preferred embodiment of the heating and drying system, the monitoring and control unit is designed to close the access paths for air to the adsorbent, provided by means of the valve unit, when after a rise in the temperature of the adsorbent owing to adsorption of water vapor by the adsorbent a difference in the temperature of the adsorbent and a temperature of the operating fluid of the motor vehicle falls below a first predetermined value. The first predetermined value can be advantageously deposited in a storage unit of the monitoring and control unit. Thereby, in an initial phase of an operation of the motor vehicle, from a state in which the temperatures of the operating fluids lie below the desired operating temperatures, heat can be transferred to the operating fluid in an efficient manner.

Furthermore, the monitoring and control is provided to open the access paths, provided by means of the valve unit, for air to the adsorbent, when a difference in the temperature of the waste heat source of the motor vehicle and the temperature of the adsorbent exceeds a second predetermined value. The second predetermined value can be advantageously likewise deposited in the storage unit of the monitoring and control unit.

Thereby, a desorption of the water adsorbed at the adsorbent can be achieved in an efficient manner and automatically, using the heat from the waste heat source of the motor vehicle, whereby the heating and drying device is prepared for a further use for the transmission of heat to the operating fluid of the motor vehicle.

### DRAWINGS

Further advantages will emerge from the following description of the drawings. In the drawings, an example embodiment of the invention is illustrated. The drawings, the description and the claims contain numerous features in combination. The specialist in the art will expediently also consider the features individually and unite them into expedient further combinations.

There is shown:

FIG. 1 a diagrammatic illustration of a heating and drying system according to the invention, for use in a motor vehicle.

### DESCRIPTION OF THE EXAMPLE EMBODIMENT

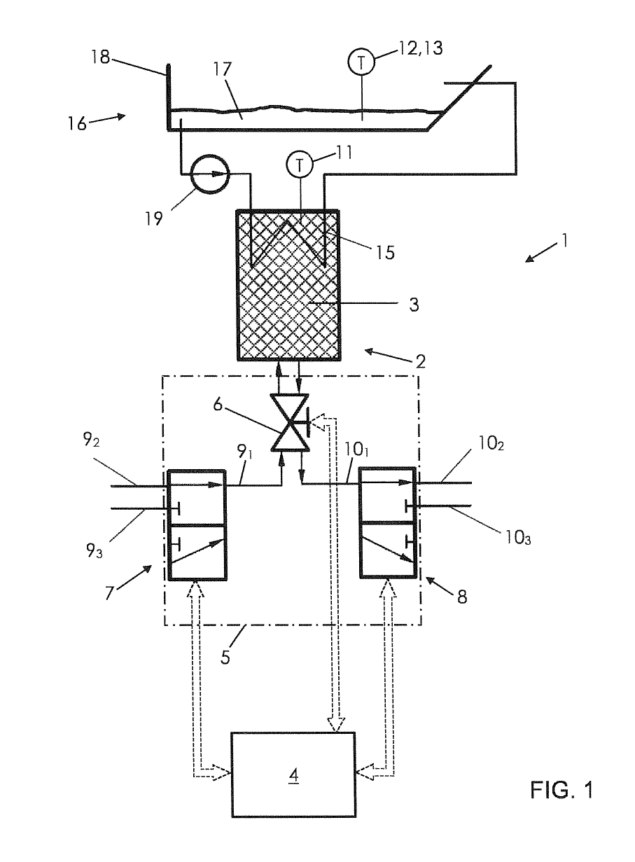

FIG. 1 shows in a flow diagram a diagrammatic illustration of a heating and drying system according to the invention for use in a motor vehicle. Although the heating and drying system is described below by means of a use in a motor vehicle constructed as a passenger vehicle with an internal combustion engine, it can generally also be used in other motor vehicles, for example in electric vehicles or motor vehicles with hybrid drive.

The heating and drying system comprises a heating and drying device 1, a plurality of temperature sensors 11, 12, 13 and a monitoring and control unit 4.

The heating and drying device 1 has an adsorption unit 2 with an adsorbent 3 formed by zeolite, which is suitable for the reversible adsorption or respectively desorption of water vapor or respectively of water in liquid form, if applicable of a mixture of water and an antifreeze agent. The absorbent 3 is arranged in a hermetically sealable housing of the adsorption unit 2. The housing consists predominantly of vacuum-tight plastic and is provided with a thermal insulation, so that the adsorbent 3 is thermally insulated with respect to the environment in a sufficient manner.

In addition, the heating and drying device 1 has a heat exchanger 15, which is integrated in the housing of the adsorption unit 2. The heat exchanger 15 is in heat-transferring contact both with the adsorbent 3 of the adsorption unit 2 and also with a waste heat source 16 that is active at least when the motor vehicle is in operation, and is made from metal, in order to achieve good heat transmission values to the adsorbent 3.

The waste heat source 16 that is active when the motor vehicle is in operation is formed by an operating fluid 17 of the motor vehicle. Terminal connections of the heat exchanger 15 are directed out from the housing of the adsorption unit 2, without impairing its sealing with respect to the environment, and are connected with opposite sides of the oil sump 18. A circulating pump 19 of the heating and drying device 1 is provided, on activation, to convey the engine oil out from the oil sump 18 through the second heat exchanger 15 back to the oil sump. The heat exchanger 15 is provided in this way to transfer, in at least one operating state, heat from the operating fluid 17 of the motor vehicle to the adsorbent 3 of the adsorption unit 2.

The operating fluid 17 of the motor vehicle is formed by engine oil, which is received in an oil sump 18 of the motor vehicle. Alternatively, the operating fluid 17 can also be formed by gear oil or coolant, wherein the known housings suitable for this are used. The heat exchanger 15 is also provided to transfer, in at least one operating state, heat from the adsorbent 3 to the operating fluid 17 of the motor vehicle.

Furthermore, the heating and drying device 1 contains a valve unit 5, which comprises a vacuum valve 6 and two 3/2-way valves 7, 8. Both the vacuum valve 6 and also the two 3/2-way valves 7, 8 are able to be controlled electrically. The valve unit 5 is designed for the provision of access paths of air to the adsorbent 3 and for the control of an access of the air to the adsorbent 3. The vacuum valve 6 is embodied so that it has two inlet openings and two outlet openings. In a first position, the vacuum valve 6 can hermetically seal the adsorption unit 2. In a second position of the vacuum valve 6, an access path of the air through the vacuum valve 6 to the adsorbent 3 and an access path of the air from the adsorbent 3 through the vacuum valve 6 are separated from one another, so that the air in the adsorption unit 2 can flow in a directed manner.

In a position of rest of the first 3/2-way valve 7, a connection 9₁ of the 3/2-way valve 7 is connected fluidically with the inlet opening of the vacuum valve 6 facing away from the adsorption unit 2. In a position of rest of the second 3/2-way valve 8, a connection 10₁ of the 3/2-way valve 8 is connected fluidically with the outlet opening of the vacuum valve 6 facing away from the adsorption unit 2. FIG. 1 shows the two 3/2-way valves 7, 8 in the position of rest.

The two remaining connections 9₂, 9₃ of the first 3/2-way valve 7 are connected fluidically with the ambient space or respectively with a vehicle cabin of the motor vehicle. The two remaining connections 10₂, 10₃ of the second 3/2-way valve are likewise connected with the ambient space or respectively with the vehicle cab of the motor vehicle.

As previously mentioned, the heating and drying system contains a plurality of temperature sensors 11, 12, 13, namely a temperature sensor 11 for determining the temperature of the adsorbent 3, a temperature sensor 12 for determining the temperature of the waste heat source 16 of the motor vehicle, and a temperature sensor 13 for determining the temperature of the operating fluid 17 of the motor vehicle. In addition, an external temperature sensor can also be connected (not illustrated). The temperature sensors 11, 12, 13 and, if applicable, the external temperature sensor, are connected with the monitoring and control unit 4 by means of electric lines or wirelessly. The temperatures determined by the temperature sensors 11, 12, 13 and, if applicable, the external temperature sensor, are captured at regular time intervals by the monitoring and control unit 4.

The monitoring and control unit 4 is designed to control the valve unit 5 for the provision of access paths of air to the adsorbent 3 and for the control of the access of air to the adsorbent 3 as a function of temperatures determined by the temperature sensors 11, 12, 13 and, if applicable, by the external temperature sensor.

A method for increasing the temperature of the operating fluid 17 of the motor vehicle and for drying the air of the vehicle cabin of the motor vehicle using the heating and drying device 1 is described below. It is assumed here that all the components and devices that are involved are in a state ready for operation and are arranged or respectively connected with one another in accordance with FIG. 1. The adsorbent 3 is to be in a state without adsorbed water, and the temperatures of the operating fluids of the motor vehicle correspond substantially to the external temperature.

The waste heat source 16 of the motor vehicle is therefore provided by the operating fluid 17 of the motor vehicle, which is formed by the engine oil situated in the oil sump 18. In a first operating state, therefore, the heat exchanger 15 is designed to transfer heat from the adsorbent 3 to the engine oil of the motor vehicle, and in a second operating state to transfer heat from the engine oil of the motor vehicle to the adsorbent 3 of the adsorption unit 2.

At low external temperatures (around +5° C. or below), after the motor vehicle is put into operation, the valve unit 5 is controlled in a first step by the monitoring and control unit 4 such that the vacuum valve 6 is opened and the first 3/2-way valve 7 and the second 3/2-way valve 8 are situated in the active position. Thereby, via the connections 9₃ and 9₁, an access path is provided for air from the vehicle cabin through the vacuum valve 6 and the adsorbent 3 and again through the vacuum valve 6 back via the connections 10₁ and 10₃ into the vehicle cabin of the motor vehicle. For the conveying of the air on this access path, provided by the valve unit 5, a ventilation unit (not illustrated), constructed as a ventilator, can be provided.

As the adsorbent 3 is in a dry state, it will adsorb a portion of the water vapor from the vehicle cabin, wherein the adsorption energy becomes free and the temperature of the adsorbent 3 increases.

In a next step, the circulating pump 19 is activated, which then conveys the engine oil out from the oil sump 18 through the heat exchanger 15 and back to the oil sump 18, wherein the engine oil receives the released adsorption energy and is heated. Through the transmission of heat from the adsorption unit 2, the engine oil reaches a desired operating temperature of, for example, 120° C., in which it has favourable viscosity characteristics, in a shorter time than without the transmission of the adsorption heat.

The air conveyed from the vehicle cabin contains, after flowing through the adsorption unit 2, a smaller amount of water vapor, so that the air of the vehicle cabin is dried by the drier air which is flowing back. Thereby, the inconvenient misting of the windows of the vehicle cabin at low external temperatures can be prevented.

At higher external temperatures (more than +5° C.) after the motor vehicle is put into operation, the valve unit 5 is controlled, in a first step, by the monitoring and control unit 4 such that the vacuum valve 6 is opened and the first 3/2-way valve 7 and the second 3/2-way valve 8 are in the position of rest. Thereby, via the connections 9₂ and 9₁, an access path is provided for air from the environment through the vacuum valve 6 and the adsorbent 3 and again through the vacuum valve 6 via the connections 10₁ and 10₂ into the environment, or respectively directed via 10₃ into the vehicle cabin.

The monitoring and control unit 4 detects at regular time intervals the temperatures determined by the temperature sensors 11, 13. Furthermore, the monitoring and control unit 4, at each temperature detection, forms a difference of the temperature of the adsorbent 3 and the temperature of the engine oil and compares this difference with a first predetermined value ΔT₁, which is deposited in a storage unit of the monitoring and control unit 4, and which is, for example, 10° C. (or respectively 10 K). When, after the rise of the temperature of the adsorbent 3 owing to the adsorption of water vapor, the difference of the temperature of the adsorbent 3 and the temperature of the engine oil falls below the first predetermined value ΔT₁, the access path for air to the adsorbent 3, provided by means of the valve unit 5, is closed by the monitoring and control unit 4 by corresponding controlling of the vacuum valve 6, and the circulating pump is switched off.

In this phase, the temperature of the adsorbent 3 decreases slowly, whilst the temperature of the engine oil increases further through the further operation of the motor vehicle. The monitoring and control unit 4 is designed, at each temperature detection, to form a difference of the temperature of the engine oil and the temperature of the adsorbent 3, and to compare it with a second predetermined value ΔT₂, which is deposited in the storage unit of the monitoring and control unit 4 and which is, for example 20° C. When the difference exceeds the second predetermined value ΔT₂, an access path for air to the adsorbent 3, provided by means of the valve unit 5, is opened by the monitoring and control unit 4 by corresponding controlling of the valve unit 5, wherein the vacuum valve 6 is opened and the first 3/2-way valve 7 and the second 3/2-way valve 8 are situated in the position of rest.

Thereby, via the connections 9₂ and 9₁, an access path for air is provided from the environment through the vacuum valve 6 and the adsorbent 3 and again through the vacuum valve 6 via the connections 10₁ and 10₂ into the environment. On reaching the second predetermined value ΔT₂, at the same time the circulating pump 19 is activated, which then conveys the engine oil from the oil sump 18 through the heat exchanger 15 and back to the oil sump 18, wherein the engine oil emits heat to the adsorbent 3. Through the transmission of heat of the corresponding temperature level to the adsorbent 3, the adsorbent 3 can desorb the adsorbed water vapor again. When the temperature of the adsorbent 3 reaches in this phase a third predetermined value ΔT₃, which is deposited in the storage unit of the monitoring and control unit 4, the access path, provided by means of the valve unit 5, for air to the adsorbent 3 is closed by the monitoring and control unit 4 by corresponding controlling of the valve unit 5. The heating and drying device 1 is then prepared again for the transmission of heat to the engine oil or respectively for drying the air of the vehicle cabin, when the motor vehicle is put into operation again and the temperature of the engine oil corresponds substantially to the external temperature.

### LIST OF REFERENCE NUMBERS

1 heating and drying device
2 adsorption unit
3 adsorbent
4 monitoring and control unit
5 valve unit
6 vacuum valve
7 3/2-way valve
8 3/2-way valve
9 valve connection
10 valve connection
11 temperature sensor adsorbent
12 temperature sensor waste heat source
13 temperature sensor operating fluid
15 heat exchanger
16 waste heat source
17 operating fluid
18 oil sump
19 circulating pump
ΔT₁ temperature difference
ΔT₂ temperature difference
ΔT₃ temperature difference

What is claimed is:

1. A heating and drying device for use in a motor vehicle, comprising:
an adsorption unit with an adsorbent, which is suitable for reversible adsorption or respectively desorption of water,
a heat exchanger, which is in heat transmitting contact both with the adsorbent of the adsorption unit and also with a waste heat source that is active at least when the motor vehicle is in operation, and, in at least one operating state, is designed to transfer heat from the waste heat source to the adsorbent of the adsorption unit, and
a valve unit, which is designed for the provision of access paths for air to the adsorbent and to control the access of the air to the adsorbent,
wherein the waste heat source is formed by an operating fluid of the motor vehicle and the heat exchanger is thereby also in heat-transferring contact with the operating fluid of the motor vehicle and is designed, in at least one operating state, to transfer heat from the adsorbent to the operating fluid of the motor vehicle.

2. The heating and drying device according to claim 1, wherein the adsorption unit has a hermetically sealable housing to receive the adsorbent.

3. The heating and drying device according to claim 1, wherein the adsorption or respectively desorption of water comprises an adsorption or respectively desorption of water vapor and/or liquid water or respectively of a liquid mixture of water and antifreeze agent.

4. The heating and drying device according to claim 1, wherein the operating fluid of the motor vehicle is selected from a group which is formed by gear oil, engine oil and coolant.

5. The heating and drying device according to claim 1, wherein at least one of the access paths provided by the valve unit is formed by a connection, capable of conducting air, between a vehicle cabin of the motor vehicle and a space surrounding the vehicle cabin.

6. The heating and drying device according to claim 1, wherein the valve unit has at least one vacuum valve.

7. The heating and drying device according to claim 1, wherein a ventilation unit, which is designed to convey air on at least one of the access paths provided by the valve unit.

8. The heating and drying device according to claim 1, wherein the adsorption unit is integrated either into a container provided for receiving the operating fluid of the vehicle, or into the waste heat source that is active when the motor vehicle is in operation.

9. A method for at least one of
an increasing of the temperature of an operating fluid of a motor vehicle and
a drying of air of a vehicle cabin of the motor vehicle
using the heating and drying device according to claim 1,
comprising the following steps:
providing, by means of the valve unit, an access path for air from at least one of air spaces which are formed by a space surrounding the vehicle cabin and the vehicle cabin of the motor vehicle, to the adsorbent,
providing, by the valve unit, an access path for air from the adsorbent to at least one of the air spaces which are formed by the space surrounding the vehicle cabin and the vehicle cabin of the motor vehicle, and
transferring of heat from the adsorption unit to the operating fluid of the motor vehicle.

10. The method according to claim 9, wherein the heating and drying device additionally comprises a temperature sensor for determining a temperature of the adsorbent, a temperature sensor for determining a temperature of the waste heat source of the motor vehicle, and a temperature sensor for determining a temperature of the operating fluid, and further including the following step:
closing the access paths for air, provided by the valve unit, when after a rise of the temperature of the adsorbent owing to the adsorption of water by the adsorbent a difference in the temperature of the adsorbent 3 and the temperature of the operating fluid of the motor vehicle falls below a first predetermined value (ΔT1).

11. A heating and drying system for use in a motor vehicle, comprising
a heating and drying device according to claim 1, wherein the valve unit comprises at least one controllable valve,
a temperature sensor for determining a temperature of the adsorbent,
a temperature sensor for determining a temperature of the waste heat source of the motor vehicle,
a temperature sensor for determining a temperature of the operating fluid of the motor vehicle,
if applicable, an external temperature sensor for determining an external temperature and
a monitoring and control unit, which is provided to control the valve unit for the provision of access paths of air to the adsorbent and to control the access of air to the adsorbent as a function of temperatures determined by the temperature sensors and, if applicable, the external temperature sensor.

12. The heating and drying system according to claim 11, wherein the monitoring and control unit is provided
to close the access paths for air, provided by the valve unit, to the absorbent, if after a rise in the temperature of the adsorbent owing to the adsorption of water by the adsorbent a difference in temperature of the adsorbent and a temperature of the operating fluid of the motor vehicle falls below a first predetermined value (ΔT1); and
to open the access paths for air, provided by means of the valve unit, to the adsorbent, when a difference in temperature of the waste heat source of the motor vehicle and the temperature of the adsorbent exceeds a second predetermined value (ΔT2).

13. The heating and drying device according to claim 2, wherein the adsorption or respectively desorption of water comprises an adsorption or respectively desorption of water vapor and/or liquid water or respectively of a liquid mixture of water and antifreeze agent.

14. The heating and drying device according to claim 13, wherein the operating fluid of the motor vehicle is selected from a group which is formed by gear oil, engine oil and coolant.

15. The heating and drying device according to claim 14, wherein at least one of the access paths provided by the valve unit is formed by a connection, capable of conducting air, between a vehicle cabin of the motor vehicle and a space surrounding the vehicle cabin.

16. The heating and drying device according to claim 15, wherein the valve unit has at least one vacuum valve.

17. The heating and drying device according to claim 16, wherein a ventilation unit, which is designed to convey air on at least one of the access paths provided by the valve unit.

18. The heating and drying device according to claim 17, wherein the adsorption unit is integrated either into a container provided for receiving the operating fluid of the vehicle, or into the waste heat source that is active when the motor vehicle is in operation.

19. A method for at least one of
an increasing of the temperature of an operating fluid of a motor vehicle and
a drying of air of a vehicle cabin of the motor vehicle
using the heating and drying device according to claim 18,
comprising the following steps:
providing, by means of the valve unit, an access path for air from at least one of air spaces which are formed by a space surrounding the vehicle cabin and the vehicle cabin of the motor vehicle, to the adsorbent,
providing, by the valve unit, an access path for air from the adsorbent to at least one of the air spaces which are formed by the space surrounding the vehicle cabin and the vehicle cabin of the motor vehicle, and
transferring of heat from the adsorption unit to the operating fluid of the motor vehicle.

20. The method according to claim 19, wherein the heating and drying device additionally comprises a temperature sensor for determining a temperature of the adsorbent, a temperature sensor for determining a temperature of the waste heat source of the motor vehicle, and a temperature sensor for determining a temperature of the operating fluid, and further including the following step:
closing the access paths for air, provided by the valve unit, when after a rise of the temperature of the adsorbent owing to the adsorption of water by the adsorbent a difference in the temperature of the adsorbent and the temperature of the operating fluid of the motor vehicle falls below a first predetermined value (ΔT1).
